(19) United States
(12) Patent Application Publication
(10) Pub. No.: US 2026/0070445 A1
(43) Pub. Date: Mar. 12, 2026

(54) HUMAN MACHINE INTERFACE (HMI) FOR ELECTRIC VEHICLE (EV) DISPENSERS

(71) Applicant: Schneider Electric USA, Inc., Boston, MA (US)

(72) Inventors: Meredith Parry BILLMAN, Smyrna, TN (US); Naman RASTOGI, Surrey (CA); Mukesh PATEL, Streamwood, IL (US)

(21) Appl. No.: 19/319,910

(22) Filed: Sep. 5, 2025

Related U.S. Application Data
(60) Provisional application No. 63/691,673, filed on Sep. 6, 2024.

(51) Int. Cl. B60L 53/30; B60L 53/60; B60L 55/00

(52) U.S. Cl. CPC B60L 53/305; B60L 53/60; B60L 55/00

(57) ABSTRACT

A bidirectional EV dispenser is described that includes an HMI to communicate with the end user a state of the EV dispenser. For example, the HMI can include a first icon or text (e.g., an image of a house) and a second icon or text (e.g., an image of an EV) with one or more light sources. In one embodiment, the HMI controls the one or more light sources to make it appear as if light is traveling from one of the icons to the other. For example, if the EV dispenser is currently charging the EV, the HMI displays a first progressive directional illumination from the icon of the house to the icon of the EV. If the EV dispenser is instead pulling power from the EV, the HMI displays a second progressive directional illumination from the icon of the EV to the icon of the house.

### CROSS-REFERENCE TO RELATED APPLICATIONS

This application claims priority to U.S. provisional patent application Ser. No. 63/691,673, filed Sep. 6, 2024. The aforementioned related patent application is herein incorporated by reference in its entirety.

### BACKGROUND

### Field

Embodiments of the present invention generally relate to dispensers for charging electric vehicles (EVs), and more particularly to human machine interfaces (HMIs) for EV dispensers.

### Description of the Related Art

Traditional EV dispensers are capable of charging the batteries of EV's. However, in residential electrical systems, it is possible to use the EV battery as a backup or storage battery, supplying power from the EV into the residential circuits. This can be done as a backup during a power outage, or simply to shift peak usage for the residence off of peak pricing of the utility grid. The traditional one-way charging EV dispensers do not have a human machine interface (HMI) suitable for a bidirectional EV dispenser, because traditionally the power flow was always from the dispenser to the EV.

### SUMMARY

One embodiment described herein is a bidirectional EV dispenser that includes a HMI including a first icon, a second icon, and one or more light sources. The bidirectional EV dispenser also includes a controller configured to control the one or more light sources to display a first progressive directional illumination from the first icon to the second icon when the EV dispenser is charging an EV and control the one or more light sources to display a second progressive directional illumination from the second icon to the first icon when the EV is providing power to the EV dispenser.

One embodiment described herein is a bidirectional EV dispenser that includes a HMI including a first icon or text corresponding to the EV dispenser or a building containing the EV dispenser corresponding to an EV, a second icon or text corresponding to an EV, and one or more light sources. The bidirectional EV dispenser including a controller configured to control the one or more light sources to display a first progressive directional illumination from the first icon or text to the second icon or text when the EV dispenser is charging the EV and control the one or more light sources to display a second progressive directional illumination from the second icon to the first icon when the EV is providing power to the EV dispenser.

One embodiment described herein is a method that includes determining power is flowing from an EV dispenser to an EV, controlling a human machine interface (HMI) on the EV dispenser to display a first progressive directional illumination from a first icon or text to a second icon or text, determining power is flowing from the EV to the EV dispenser, and controlling the HMI to display a second progressive directional illumination from the second icon or text to the first icon or text.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 illustrates a system with a bidirectional EV dispenser, according to one embodiment.

FIG. 2 is a flowchart for using a progressive directional illumination to indicate power flow in a bidirectional EV dispenser, according to one embodiment.

FIG. 3 illustrates an HMI flow indicator providing a progressive directional illumination to indicate power flow in a bidirectional EV dispenser, according to one embodiment.

FIG. 4 illustrates an HMI flow indicator providing a progressive directional illumination to indicate power flow in a bidirectional EV dispenser, according to one embodiment.

FIGS. 5A and 5B illustrate progressive directional illuminations in a bidirectional EV dispenser, according to one embodiment.

FIGS. 6A and 6B illustrate progressive directional illuminations in a bidirectional EV dispenser, according to one embodiment.

FIG. 7 is a flowchart for using pulsing lights to generate a progressive directional illumination to indicate power flow in a bidirectional EV dispenser, according to one embodiment.

FIG. 8 illustrates a control system for pulsing lights to indicate power flow in a first direction, according to one embodiment.

FIG. 9 illustrates a control system for pulsing lights to indicate power flow in a second direction, according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Traditional EV chargers or dispensers do only one function, namely charge the vehicle. With bidirectional charging the EV dispenser both charges and discharges power to and from the battery of the EV. The embodiments herein describe an HMI to communicate with the end user a state of the EV dispenser. For example, the HMI can include a first icon (e.g., an image of a house) and a second icon (e.g., an image of an EV) with a plurality of lights (e.g., light emitting diodes (LEDs)) extending between the two icons (e.g., in a straight line or an arch). In one embodiment, the HMI controls the lights to display a progressive directional illumination to make it appear as if light is traveling from one of the icons to the other. For example, if the EV dispenser is currently charging the EV, the HMI display a first progressive directional illumination traveling from the icon of the house to the icon of the EV. If instead the EV dispenser is pulling power from the EV, the HMI display a second progressive directional illumination from the icon of the EV to the icon of the house.

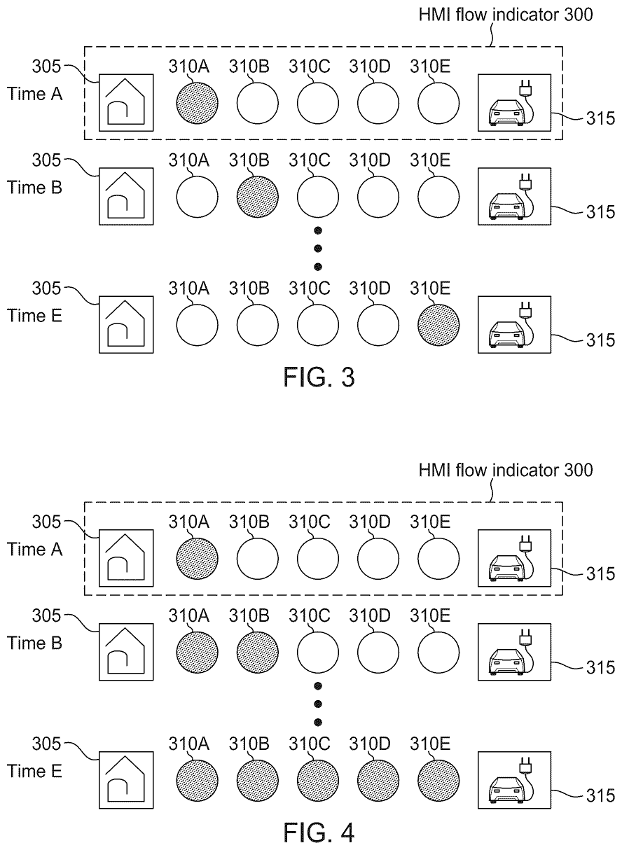

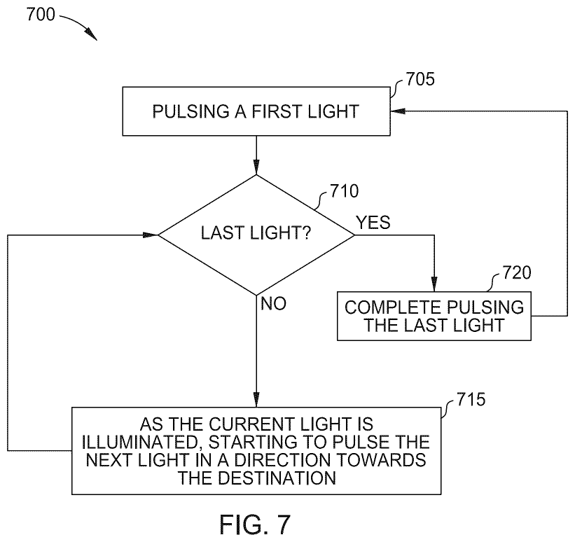

The HMI can use multiple different illumination strategies to create the appearance of traveling light. For example, the HMI may illuminate lights sequentially (e.g., turn on a first light, wait a period, turn off the first light and turn on a second light, wait a period, turn off the second light and turn on a third light, etc.). This is illustrated in FIG. 3. In another example, the HMI keep on the previously illuminated lights as it turns on the next lights. This is illustrated in FIG. 4. In yet another example, the HMI may iteratively turn on the lights, but pulse the lights (e.g., gradually increase until reaching a maximum brightness and then gradually decreasing their brightness). Further, the HMI may start to pulse the next light while the current light has not completely turned off. This is discussed in FIGS. 7-9. Moreover, a diffuser can be used to mix the light emitted by multiple lights so that the lights are not individually viewable to the user, which can improve the smoothness of the progressive directional illumination across the HMI.

Regardless of the particular illumination strategy used, progressive directional illuminations provide an easy to recognize visual indicator to the user of the direction power is flowing in the EV dispenser (e.g., either to the EV, or from the EV). As such, a user can quickly ascertain the state of the EV dispenser, whether it is charging the EV or receiving power from the EV. In addition, the HMI can be used to indicate other EV dispenser states to the user such as initialization, pin code resets, firmware updates, errors, when charge is complete, and the like.

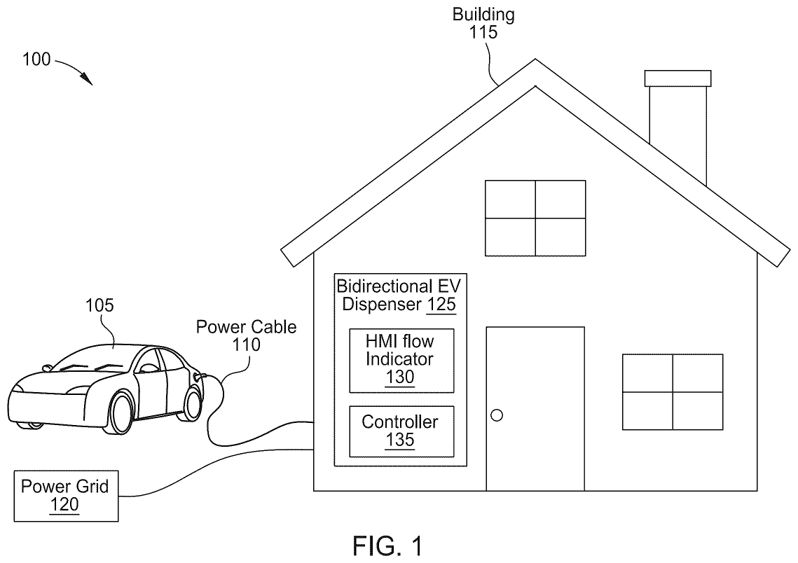

FIG. 1 illustrates a system 100 with a bidirectional EV dispenser 125, according to one embodiment. The EV dispenser 125 is disposed in a building 115, which can be a residential house, an apartment building, and the like. Typically, the bidirectional EV dispenser 125 provides power (i.e., charges the EV 105) when coupled to the EV 105 via a power cable 110. For example, the building 115 can include an electrical panel that is coupled to a power grid 120. The EV dispenser 125 can be coupled to (or be part of) the electrical panel so that the dispenser 125 can use power from the grid 120 to charge the EV 105.

However, there are instances when the battery in the EV 105 is used to power electrical devices in the building 115. In that case, electrical current passes from a battery of the EV 105, through the EV dispenser 125, and to the building electrical panel, which can distribute the current to the electrical devices in the building 115. This may be performed when there is a power outage where the grid 120 is down. In another example, the EV dispenser 125 charges the EV 105 when the utility grid rates are low (e.g., during nighttime or low usage) but then pulls power from the EV 105 when grid rates are high (e.g., when customer demand is high). In that case, the EV 105 may provide all the power for the building 115, or at least provide supplemental power for the building 115 to reduce the amount of power that is consumed from the power grid 120.

The bidirectional EV dispenser 125 includes an HMI flow indicator 130 that provides a visual output to indicate the current state of the EV dispenser 125. While the HMI flow indicator 130 can provide different visual indications for a wide variety of states (e.g., initialization, pin code resets, firmware updates, errors, when charge is complete, etc.) the embodiments below specifically discuss providing visual indications when power flows from the dispenser 125 to the EV 105 and when power flows from the EV 105 to the dispenser 125 (e.g., to power electrical devices in the building 115). In one embodiment, as discussed in more detail below, the HMI flow indicator 130 uses one or more light sources display a progressive directional illumination to simulate light traveling between an icon (or text) representing the building 115 and an icon (or text) representing the EV 105. The direction of this illumination can indicate whether the EV 105 is receiving power, or providing power.

The bidirectional EV dispenser 125 also includes a controller 135 that controls the dispenser 125. For example, the controller 135 can control the HMI flow indicator 130 based on the state of the EV dispenser 125 (e.g., to control the direction of the progressive directional illumination in the HMI flow indicator 130). The controller 135 can represent hardware, software, and combinations thereof. For example, the controller 135 can include one or more integrated circuits (e.g., application specific integrated circuits, processors, field programmable gate arrays (FPGAs), system on a chip (SoC), programmable logic controller (PLC), etc.). The controller 135 can also include firmware or software for performing the functions described herein. For instance, the controller 135 can include memory that stores a light-weight operating system which is executed by a processor in the controller 135.

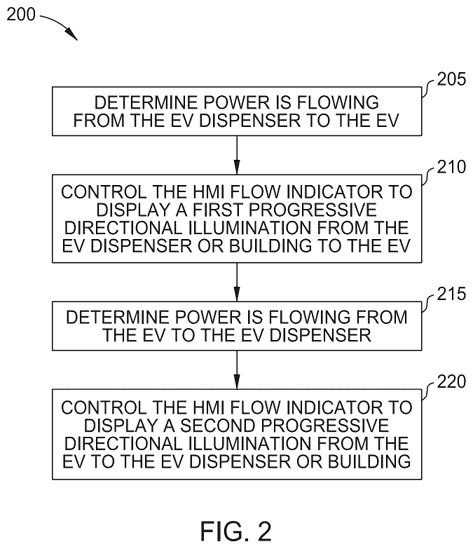

FIG. 2 is a flowchart of a method 200 for using a progressive directional illumination to indicate power flow in a bidirectional EV dispenser, according to one embodiment. At block 205, a controller (e.g., the controller 135 in FIG. 1) determines power is flowing from the EV dispenser to the EV. That is, the controller determines the EV dispenser is in a first state where the dispenser charges the battery in the EV using, e.g., power from a grid.

At block 210, the controller controls the HMI flow indicator (e.g., the HMI flow indicator 130 in FIG. 1) to display a progressive directional illumination from the EV dispenser (or building that includes the EV dispenser) to the EV. For example, the HMI flow indicator can include an icon or text representing the EV (e.g., an image of an EV) and an icon or text representing the building (e.g., an image of a house). The controller can control the illumination of lights that extend between these icons to make it appear as if light is moving from the icon of the building to the icon of the EV, thereby mimicking the flow of power from the EV dispenser in the building to the EV. Examples of various illumination techniques for generating progressive directional illuminations are discussed in FIGS. 3-6 below.

At block 215, the controller determines power is flowing from the EV to the EV dispenser. For example, there may be a blackout where the battery in the EV is now used to power electrical devices in the building, or power in the EV may be used to mitigate the amount of power pulled from the grid when grid rates are high.

This switch in power flow can happen automatically or in response to a user command. For example, if there is a blackout, this may be automatically detected by the EV dispenser which switches to pulling power from the EV. Or the EV dispenser may have a timer to know when grid rates increase, and in response, begin pulling power from the EV. Alternatively, the EV dispenser may have one or more input/output (I/O) devices that can be used by a user to instruct the EV dispenser to begin pulling power from the EV. For instance, a user may press a button on the EV dispenser to cause it to begin pulling power from the EV.

At block 220, the controller controls the HMI flow indicator to display a progressive directional illumination from the EV to the EV dispenser or building. In one embodiment, the illumination travels in the opposite direction that it did at block 210. For example, the controller can control the illumination of lights to make it appear as if light is moving from the icon of the EV to the icon of the building, thereby mimicking the flow of power from the EV to the building.

The method 200 enables EV owners to plug in an EV and know if it has started charging. In a bidirectional charging application, users want to know what the EV is doing once it is plugged in to the home/residential EV dispenser without having to check an app or the car's dashboard. Also, when unplugging the car, the EV owner should know if the EV is charging or discharging. The method 200 can provide this information visually to the end user via the HMI flow indicator.

FIG. 3 illustrates an HMI flow indicator 300 providing a progressive directional illumination to indicate power flow in a bidirectional EV dispenser, according to one embodiment. The HMI flow indicator 300 includes a plurality of lights 310A-E (e.g., LEDs) that extends between a building icon 305 and an EV icon 315. These icons 305, 315 can be printed images of a building or an EV on the HMI, or can be embossed onto, or etched into, the surface of the HMI flow indicator 300. While FIG. 3 illustrates using icons, in other embodiments text can be used such as “HOUSE” and “CAR” instead of icons.

FIG. 3 also illustrates different illumination states of the HMI flow indicator at different time periods—i.e., Time A, Time B, . . . , Time E when the EV dispenser is charging the EV. That is, power is currently flowing from the EV dispenser to the EV. To indicate this flow of power visually, at Time A the controller illuminates the light 310A while the lights 310B-E remain unilluminated.

After a delay, at Time B, the controller illuminates the light 310B while the light 310A is turned off. Moreover, lights 310C-E remain unilluminated. As such, when progressing from Time A to Time B, it appears to the user that light has traveled from the location of the light 310A to the location of the light 310B. This can repeat where the controller then illuminates the light 310C during the next time period (while the other lights are unilluminated) and then illuminates the light 310D during the next time period (while the other lights are unilluminated).

At Time E, the light 310E is illuminated while the other lights 310A-D are unilluminated. In one embodiment, the lights 310A-E may be illuminated for the same period of time. Further, in one implementation, only one of the lights 310 is illuminated at any given time. For example, when light 310B is illuminated, light 310A is immediately turned off. However, in other embodiment, two lights may be illuminated for a brief period of time. For example, when light 310B is illuminated, the lights 310A may remain illuminated for a few hundreds of microseconds before turning off. This may make the traversal of the light signal from the icon 305 to the icon 315 appear smoother. Further, a diffuser can be disposed over the lights 310 to further smooth the movement of the progressive directional illumination.

In this manner, the lights 310A-E can form a light pipe, animating a flow of light between the building icon 305 and the EV icon 315 to visually communicate the direction of charging. This gives the user an intuitive visual queue for knowing how power is flowing through the EV dispenser.

After Time E, the controller can turn off the light 310E and the process can repeat at Time A. So long as the EV dispenser continues to charge the EV, the process shown at Times A-E can repeat to mimic the flow of power to the EV.

When the state of the EV dispenser is changed and the EV begins providing power to the building, the process shown in FIG. 3 can be reversed where the light 310E first illuminates, followed by the light 310D, followed by the light 310C, and so forth. In this manner, the HMI flow indicator 300 can generate a traveling light signal that mimics the flow of power between a building and an EV using the icons 305 and 315 and sequentially illuminating the lights 310.

In one embodiment, the icons 305 and 315 can be backlit using respective lights. In that case, when the EV dispenser is charging the EV, the light behind the EV icon 315 can be illuminated so that this icon is brighter (or more viewable to the user) than the building icon 305. Conversely, when power is flowing from the EV to the building, the light behind the building icon 305 can be illuminated (but not the EV icon 315). Selectively backlighting the icons 305 and 315 can provide a further indicator to the user (along with the illumination pattern of the lights 310A-E) of the destination of the power flow.

FIG. 4 illustrates the same HMI flow indicator 300 as shown in FIG. 3 but with a different illumination technique, according to one embodiment. That is, the HMI flow indicator 300 in FIG. 4 is structurally the same as the indicator 300 in FIG. 300, but is controlled differently.

Like in FIG. 3, FIG. 4 also illustrates different illumination states of the HMI flow indicator 300 at different time periods—i.e., Time A, Time B, . . . , Time E when the EV dispenser is charging the EV. That is, power is currently flowing from the EV dispenser to the EV. To indicate this flow of power visually, at Time A the controller illuminates the light 310A while the lights 310B-E remain unilluminated.

At Time B, the controller illuminates the light 310B while the light 310A remains illuminated. Moreover, the lights 310C-E remain unilluminated. As such, when progressing from Time A to Time B, it appears to the user that light is extending from the building icon 305 in a direction to the EV icon 315. This can repeat where the controller then illuminates the light 310C during the next time period (while the lights 310A and 310B remain illuminated but lights 310D and 310E remain unilluminated) and then illuminates the light 310D during the next time period (while the lights 310A-C remain illuminated and the light 310E remains unilluminated).

At Time E, all the lights 310A-E are illuminated. In one embodiment, the next light in the sequence is turned on after a constant delay (e.g., the light 310A is turned for one second then the light 310B is turned on, then one second later light 310C is turned on, then one second later light 310D is turned on, and so forth). As such, the light signal appears to extend towards the icon 315 at a constant interval. Further, a diffuser can be disposed over the lights 310 to further smooth the movement of the progressive directional illumination.

After Time E, the controller can turn off all the lights 310 and the process can repeat at Time A. That is, so long as the EV dispenser continues to charge the EV, the process shown in Times A-E can repeat to mimic the flow of power to the EV.

When the state of the EV dispenser is changed and the EV begins providing power to the building, the process shown in FIG. 4 is reversed where the light 310E first illuminates, followed by the light 310D, followed by the light 310C, and so forth. In this manner, the HMI flow indicator 300 can generate a traveling light signal that mimics the flow of power between a building and an EV using the icons 305 and 315 and sequentially illuminating the lights 310.

While FIGS. 3 and 4 illustrate using multiple lights 310 (e.g., multiple light sources) to generate progressive directional illuminations, in other HMI flow indicators a single light source could be used. For example, a laser (or a directional light) disposed within the EV dispenser could be steered or swept to illuminate a semi-transparent surface of the dispenser that extends between the icon 305 and the icon 315. When the dispenser is charging the EV, the laser can first illuminate the part of the semi-transparent surface that is closest to the icon 305 and then be adjusted to make the light move towards the icon 315. As such, the laser creates a light signal on the semi-transparent surface that moves from the icon 305 to the icon 315. When the laser reaches the icon 315, the laser can be turned off and then adjusted so that the laser again points to the portion of the semi-transparent surface closest to the icon 305. The laser can be turned on and again steered or swept towards the icon 315, thereby repeating the process. This process is reversed when the EV is instead providing power to the building so the laser creates a light signal that travels from the icon 315 to the icon 305. In this manner, an HMI flow indicator with a single light source can be used to create a progressive directional illumination.

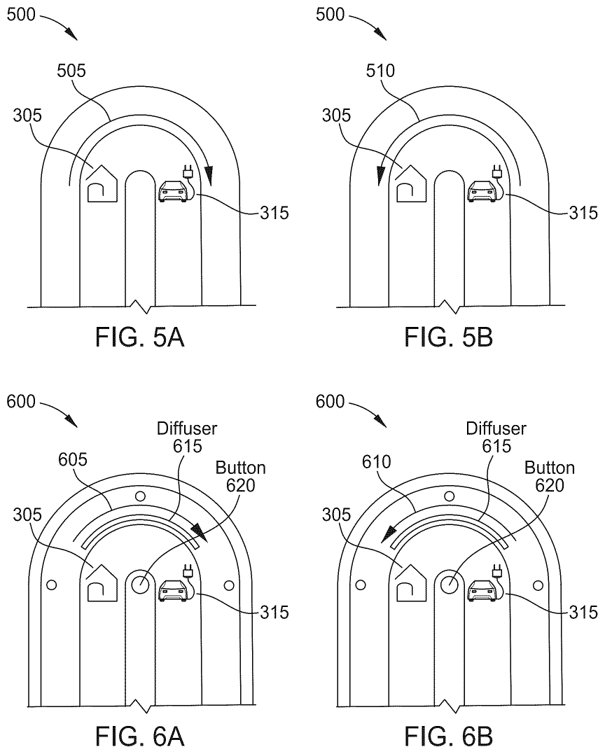

FIGS. 5A and 5B illustrate progressive directional illuminations in a bidirectional EV dispenser 500, according to one embodiment. In FIG. 5A, the dispenser 500 has an arch in which multiple lights (e.g., multiple LEDs) are embedded. The arch connects the building icon 305 to the EV icon 315. Using any of the illumination techniques discussed above, these lights can be controlled so that the progressive directional illumination travels along the arch shown by the arrow 505. That is, the light travels from the building icon 305 to the EV icon 315. To further smooth out the progressive directional illumination, the arch can include a diffuser (not shown) that covers the lights. In addition, instead of using multiple lights, the dispenser 500 could instead include a directional light, such as a laser, which can sweep across the arch to form the traveling light signal.

FIG. 5B also illustrates the bidirectional EV dispenser 500 but at a time when power is flowing from the EV to the building. To mimic this flow, the lights in the arch are controlled so that light travels along the arch shown by the arrow 510. That is, the progressive directional illumination travels from the EV icon 315 to the building icon 305. This can be performed using any of the illumination techniques discussed above.

In one embodiment, the lights are color coded where the lights are one color (e.g., green) when generating a progressive directional illumination from the EV icon 315 to the building icon 305 but a different color (e.g., blue) when generating light traveling from the building icon 305 to the EV icon 315. For example, the lights may be LEDs that output different colors. Multi-color LEDs can also be useful when illustrating other states of the EV dispenser (e.g., red to indicate an error state).

FIGS. 6A and 6B illustrate progressive directional illuminations in a bidirectional EV dispenser 600, according to one embodiment. In FIG. 6A, the dispenser 600 has a diffuser 615 forming an arch on the surface of the dispenser 600. Like in FIGS. 5A and 5B, multiple lights (e.g., multiple LEDs) can be embedded underneath the diffuser 615. The diffuser 615 connects the building icon 305 to the EV icon 315. Using any of the illumination techniques discussed above, these lights can be controlled so that progressive directional illumination travels along the arch formed by the diffuser 615 as shown by the arrow 605. That is, the light travels from the building icon 305 to the EV icon 315. In addition, instead of using multiple lights, the dispenser 600 could instead include a directional light, such as a laser, which can sweep along the diffuser 615 to form the traveling light signal.

FIG. 6B also illustrates the bidirectional EV dispenser 600 in FIG. 6A but at a time when power is flowing from the EV to the building. To mimic this flow, the lights in the arch are controlled so that progressive directional illumination travels along the diffuser 615 as shown by the arrow 610. That is, the light travels from the EV icon 315 to the building icon 305. This can be performed using any of the illumination techniques discussed above.

FIGS. 6A and 6B also illustrate a button 620 which may be used to change the charging state of the dispenser 600. For example, a user may press the button 620 on the EV dispenser to cause it to begin pulling power from the EV, or to begin charging the EV.

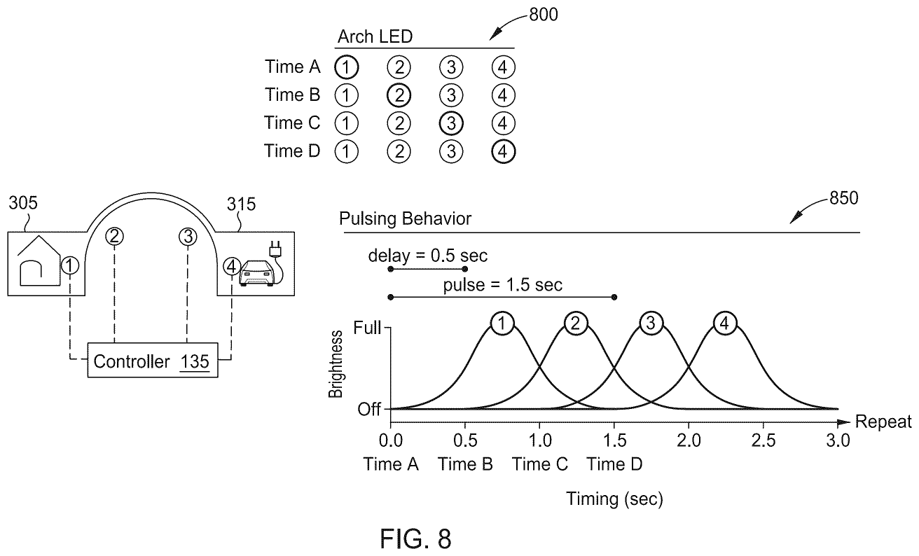

FIG. 7 is a flowchart of a method 700 for using pulsing lights to generate a progressive directional illumination to indicate power flow in a bidirectional EV dispenser, according to one embodiment. The method 700 describes illumination techniques where a plurality of lights is pulsed such that their brightness gradually increases to a maximum brightness and then gradually decreases. Further, each sequential light can start to be pulsed while the previous light is still illuminated (e.g., multiple lights can be illuminated at the same time). For ease of explanation, the method 700 is discussed in tandem with FIG. 8 which illustrates a control system for pulsing lights to indicate power flow in a first direction.

At block 705, the controller pulses a first light. For example, FIG. 8 illustrates the controller 135 coupled to multiple lights (labeled 1-4) that extend in an arch from the building icon 305 to the EV icon 315. At Time A, the controller 135 begins to pulse Light 1. This is shown in chart 800 and graph 850 where at Time A, Light 1 is turned on and its brightness is gradually increased.

Returning to method 700, the controller determines whether the last light is currently illuminated. Since only the first light has been illuminated as this time, the method 700 proceeds to block 715 where the controller starts to pulse the next light in the direction towards the destination while the current light is illuminated. For example, at Time B in FIG. 8, the controller 135 starts to pulse Light 2. As shown by the graph 850, Light 1 is still illuminated at Time B, and in fact, is still increasing in brightness. Thus, at Time B, the controller 135 increases the brightness of both neighboring Lights 1 and 2.

The method 700 returns to block 710, and since there are still more lights to illuminate before reaching the destination (e.g., the light closest to the EV icon 315), the controller turns on the next light in the arch. This is illustrated in FIG. 8 at Time C where the controller 135 begins to pulse Light 3. At this time, the controller 135 is reducing the brightness of Light 1 (i.e., Light 1 is being dimmed) while the brightness of Light 2 is still being increased. Thus, at Time C, there are three lights turned on at the same time albeit with varying brightnesses.

Blocks 710 and 715 repeat again, and at Time D the controller 135 in FIG. 8 turns on the last light (i.e., Light 4). At this time, Light 1 has been turned off and the controller 135 is reducing the brightness of Light 2 while the brightness of Light 3 is still being increased. Thus, at Time D, there are three lights turned on at the same time but with varying brightnesses.

Because the last light has been illuminated, the method 700 proceeds to block 720 where the controller completes pulsing the last light (and any other lights that may be illuminated). As shown by the graph 850 in FIG. 8, after Time D, Light 2 is gradually dimmed until it turns off at 2 second, Light 3 increases in brightness for a short period before being dimmed and turned off at 2.5 seconds, and Light 4 increases in brightness until approximately 2.25 seconds before being dimmed and turned off at 3 seconds. Thus, graph 850 illustrates a progressive directional illumination from the building icon 305 to the EV icon 315 in a time period of 3 seconds, but this is just only one example. The traversal time of the light signal between the icons 305 and 315 may vary depending on any number of factors such as the brightness of the lights or the distance between the icons.

After the last light has completed being pulsed, the method 700 can then repeat at block 705. However, in other embodiments, the method 700 may repeat before the last light has completed turned off. For example, in FIG. 8, the controller 135 may begin to pulse Light 1 before Light 4 has completely turned off (e.g., before 3 seconds).

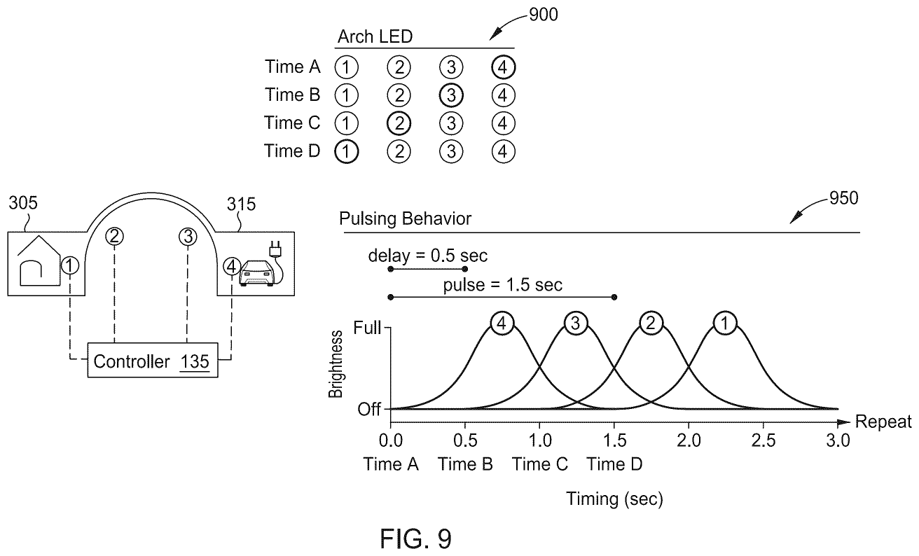

FIG. 9 illustrates a control system for pulsing lights to indicate power flow in a second direction, according to one embodiment. The control system in FIG. 9 is the same control system shown in FIG. 8 where a controller 135 is coupled to Lights 1-4. In FIG. 9, it is assumed that power is flowing from the EV to the EV dispenser (e.g., to power electrical devices in the building containing the EV dispenser). To mimic this power flow, at Time A the controller 135 begins to pulse Light 4. This is shown in chart 900 and graph 950 where at Time A, Light 4 is turned on.

After a delay where only Light 4 is pulsed, at Time B, the controller 135 starts to pulse Light 3. As shown by the graph 950, Light 4 is still illuminated at Time B, and in fact, is still increasing in brightness. Thus, at Time B, the controller 135 increases the brightness of both neighboring Lights 3 and 4.

At Time C the controller 135 begins to pulse Light 2. At this time, the controller 135 is reducing the brightness of Light 4 (i.e., Light 4 is being dimmed) while the brightness of Light 3 is still being increased. Thus, at Time C, there are three lights turned on at the same time but with different brightnesses.

At Time D the controller 135 turns on the last light (i.e., Light 1) which is closest to the building icon 305. At this time, Light 4 has been turned off and the controller 135 is reducing the brightness of Light 3 while the brightness of Light 2 is still being increased. Thus, at Time D, there are three lights turned on at the same time but with different brightnesses.

After Time D, the controller 135 continues to pulse the Lights 3, 2, and 1, where Light 3 is turned off first, then Light 2, and finally Light 1. This process can then repeat (e.g., return to Time A in the graph 950) after Light 1 is turned off. However, in other embodiments, the process in FIG. 9 may repeat before the last light has completely turned off. For example, the controller 135 may begin to pulse Light 4 before Light 1 has completely turned off (e.g., before 3 seconds).

In this manner, FIGS. 8 and 9 illustrate pulsing lights in an overlapping manner to illustrate progressive directional illuminations between the building icon 305 and the EV icon 315 to mimic power flow in the real-world.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

What is claimed is:

1. A bidirectional electric vehicle (EV) dispenser comprising:
a human machine interface (HMI) comprising:
a first icon,
a second icon, and
one or more light sources; and
a controller configured to:
control the one or more light sources to display a first progressive directional illumination from the first icon to the second icon when the EV dispenser is charging an EV, and
control the one or more light sources to display a second progressive directional illumination from the second icon to the first icon when the EV is providing power to the EV dispenser.

2. The bidirectional EV dispenser of claim 1, wherein controlling the one or more light sources to display the first progressive directional illumination from the first icon to the second icon comprises:
sequentially illuminating a plurality of lights that extend between the first and second icons.

3. The bidirectional EV dispenser of claim 2, wherein each of the plurality of lights is pulsed when being sequentially illuminated.

4. The bidirectional EV dispenser of claim 3, wherein, during a first time, at least two neighboring lights of the plurality of lights are being pulsed at the same time but have different brightnesses.

5. The bidirectional EV dispenser of claim 2, wherein no two lights of the plurality of lights are illuminated at the same time.

6. The bidirectional EV dispenser of claim 2, wherein a diffuser is disposed over the plurality of lights.

7. The bidirectional EV dispenser of claim 1, wherein controlling the one or more light sources to display the first progressive directional illumination from the first icon to the second icon comprises:
repeatedly determining that the first progressive directional illumination has reached the second icon and controlling the one or more lights source to display the first progressive directional illumination from the first icon to the second icon.

8. The bidirectional EV dispenser of claim 1, wherein the one or more light sources comprises a laser that can be steered or swept to generate the first and second progressive directional illuminations.

9. The bidirectional EV dispenser of claim 1, wherein the second icon represents the EV.

10. The bidirectional EV dispenser of claim 1, wherein the first icon represents the EV dispenser or a building containing the EV dispenser.

11. A bidirectional electric vehicle (EV) dispenser comprising:
a human machine interface (HMI) comprising:
a first icon or text corresponding to the EV dispenser or a building containing the EV dispenser corresponding to an EV,
a second icon or text corresponding to an EV, and
one or more light sources; and
a controller configured to:
control the one or more light sources to display a first progressive directional illumination from the first icon or text to the second icon or text when the EV dispenser is charging the EV, and
control the one or more light sources to display a second progressive directional illumination from the second icon to the first icon when the EV is providing power to the EV dispenser.

12. The bidirectional EV dispenser of claim 11, wherein controlling the one or more light sources to display the first progressive directional illumination from the first icon or text to the second icon or text comprises:
sequentially illuminating a plurality of lights that extend between the first icon or text and the second icon or text.

13. The bidirectional EV dispenser of claim 12, wherein each of the plurality of lights is pulsed when being sequentially illuminated.

14. The bidirectional EV dispenser of claim 13, wherein, during a first time, at least two neighboring lights of the plurality of lights are being pulsed at the same time but have different brightnesses.

15. The bidirectional EV dispenser of claim 12, wherein no two lights of the plurality of lights are illuminated at the same time.

16. The bidirectional EV dispenser of claim 12, wherein a diffuser is disposed over the plurality of lights.

17. The bidirectional EV dispenser of claim 11, wherein controlling the one or more light sources to display the first progressive directional illumination from the first icon or text to the second icon or text comprises:
repeatedly determining that the first progressive directional illumination has reached the second icon or text and controlling the one or more lights source to display the first progressive directional illumination from the first icon or text to the second icon or text.

18. The bidirectional EV dispenser of claim 11, wherein the one or more light sources comprises a laser that can be steered or swept to generate the first and second progressive directional illuminations.

19. A method comprising:
determining power is flowing from an electric vehicle (EV) dispenser to an EV;
controlling a human machine interface (HMI) on the EV dispenser to display a first progressive directional illumination from a first icon or text to a second icon or text;
determining power is flowing from the EV to the EV dispenser; and
controlling the HMI to display a second progressive directional illumination from the second icon or text to the first icon or text.

20. The method of claim 19, wherein the first icon or text corresponds to the EV dispenser or a building containing the EV dispenser and the second icon or text corresponds to the EV.
